(19) United States
(12) Patent Application Publication
(10) Pub. No.: US 2007/0180814 A1
(43) Pub. Date: Aug. 9, 2007

(54) Direct liquid fuel injection and ignition for a pulse detonation combustor

(75) Inventors: Venkat Eswarlu Tangirala, Niskayuna, NY (US); Kevin Michael Hinckley, Saratoga, NY (US); David Michael Chapin, Niskayuna, NY (US); Anthony John Dean, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/347,464

(22) Filed: Feb. 3, 2006

(51) Int. Cl. F02K 7/02

(52) U.S. Cl. 60/204; 60/247

(57) ABSTRACT

A system for generating thrust is provided. The system includes a first injector, an inner tube configured to receive fuel from the first injector via a first port of the inner tube, where at least a portion of fuel in liquid phase received by the inner tube is configured to flash vaporize upon entering the inner tube via the first port.

### BACKGROUND OF THE INVENTION

The present invention generally relates cyclic pulsed detonation combustors (PDCs) and more particularly, to two-phase fuel injection and ignition of fuel-oxidizer mixture to obtain reliable detonation initiations in the combustor.

In a generalized pulse detonation combustor, fuel (vapor phase or liquid phase), and oxidizer (e.g., oxygen-containing gas) are admitted to an elongated combustion chamber at an upstream inlet end. An igniter is used to initiate this combustion process. Following a successful transition to detonation, a detonation wave propagates toward the outlet at supersonic speed causing substantial combustion of the fuel/oxidizer mixture before the mixture can be substantially driven from the outlet. The result of the combustion is to rapidly elevate pressure within the combustor before a substantial amount of gas can escape through the combustor exit. The effect of this inertial confinement is to produce near constant volume combustion. Such devices can be used to produce pure thrust or can be integrated in a gas-turbine engine. The former is generally termed a pure thrust-producing device and the latter is termed a hybrid engine device. A pure thrust-producing device is often used in a subsonic or supersonic propulsion vehicle system such as rockets, missiles and afterburners of turbojet engines. Industrial gas turbines are often used to provide output power to drive an electrical generator or motor. Other types of gas turbines may be used as aircraft engines, on-site and supplemental power generators, and for other applications.

A deflagration-to-detonation transition (DDT) process begins when a fuel-oxidizer mixture in the chamber is ignited via a spark or other source. The subsonic flame generated from the spark accelerates as it travels along the length of the chamber due to various chemical and flow mechanics. As the flame reaches critical speeds, “hot spots” are created that create localized explosions, eventually transitioning the flame to a super sonic detonation wave. The DDT process can take up to several meters of the length of the chamber, and efforts have been made to reduce the distance required for DDT by using internal obstacles in the flow. The time scale of the fuel fill and the DDT process can be high for hydrocarbon-oxidizer mixtures, which can increase the overall cycle time, which in turn can adversely affect the generation of thrust. The time scale of the fuel fill and the DDT process is a time at which the detonation wave exits the chamber.

### BRIEF DESCRIPTION OF THE INVENTION

In one aspect, a system for generating thrust is provided. The system includes a first injector, an inner tube configured to receive fuel from the first injector via a first port of the inner tube, where at least a portion of fuel in liquid phase received by the inner tube is configured to flash vaporize upon entering the inner tube via the first port.

A system for generating energy is provided. The system includes a compressor configured to compressed oxidizer, a first injector, and an inner tube configured to receive fuel from the first injector via a first port of the inner tube, where at least a portion of fuel received by the inner tube configured to flash vaporize upon entering the inner tube via the first port.

A method for generating thrust is provided. The method includes receiving fuel from a first injector via a first port of an inner tube, and flash vaporizing at least a portion of the fuel received via the first port upon entering the inner tube.

### BRIEF DESCRIPTION OF THE DRAWINGS

FIG. 1 is a block diagram of an exemplary embodiment of a system for generating thrust.

FIG. 2 is a flow diagram of an exemplary method for generating thrust.

FIG. 3 is a schematic diagram of an alternative embodiment of a system for generating thrust.

FIG. 4 is a flow diagram of another exemplary method for generating thrust.

FIG. 5 is a schematic diagram of another alternative embodiment of a system for generating thrust.

FIG. 6 is a flow diagram of yet another exemplary method for generating thrust.

FIG. 7 is a schematic diagram of yet another alternative embodiment of a system for generating thrust.

FIG. 8 is a cross-sectional view of the system of FIG. 7.

FIG. 9 is a flow diagram of still another exemplary method for generating thrust.

FIG. 10 is a schematic of an exemplary gas turbine engine including the systems of FIGS. 1, 3, 5, and 7.

### DETAILED DESCRIPTION OF THE INVENTION

A pulse detonation combustor (PDC) includes a device or system that produces pressure rise, temperature rise and velocity increase from a series of repeating detonations or quasi-detonations within the PDC. In a flash vaporization process, the fuel pressure and temperature are above a critical point and hence when the fuel is injected via a pressure-assist atomizer into the PDC, which is at a lower pressure, the fuel flash vaporizes instantly there by decreasing the fuel evaporation time. An additional advantage of the flash vaporization process is improved mixing of the fuel and an oxidizer. A direct injection of a liquid fuel is performed when a plurality of liquid droplets are injected using a fuel injector downstream of any valves either on the fuel side or the oxidizer side and the fuel that is injected flows directly into the PDC. In addition, axial staging of the fuel and recirculation of heat from a plurality of walls of the PDC, and a provision to configure a preheat segment and an evaporation segment in the path of the liquid droplet-oxidizer mixture further decreases the evaporation time as well as the fuel fill time, before combustion of the fuel-oxidizer mixture occurs. A “quasidetonation” is a fast-moving, turbulent combustion wave that produces pressure rise, temperature rise and velocity increase higher than pressure rise, temperature rise and velocity increase produced by a deflagration wave. Embodiments of PDCs include a fuel injection system, an oxidizer flow system, a means of igniting a fuel/oxidizer mixture, and a detonation chamber, in which pressure wave fronts initiated by the ignition process coalesce to produce a detonation wave. Each detonation or quasidetonation is initiated either by external ignition, such as spark discharge or laser pulse, or by gas dynamic processes, such as shock focusing, autoignition or by another detonation (cross-fire). The geometry of the PDC is such that the pressure rise of the detonation wave expels combustion products out the exhaust to produce a thrust force. Pulse detonation combustion can be accomplished in a number of types of detonation chambers, including shock tubes, resonating detonation cavities and tubular/tuboannular/annular combustors. As used herein, the term “chamber” includes circular or non-circular cross-sections with constant or varying cross sectional shapes along a length of the chamber. Exemplary chambers include cylindrical chambers, as well as chambers having polygonal cross-sections, for example a hexagonal cross-section.

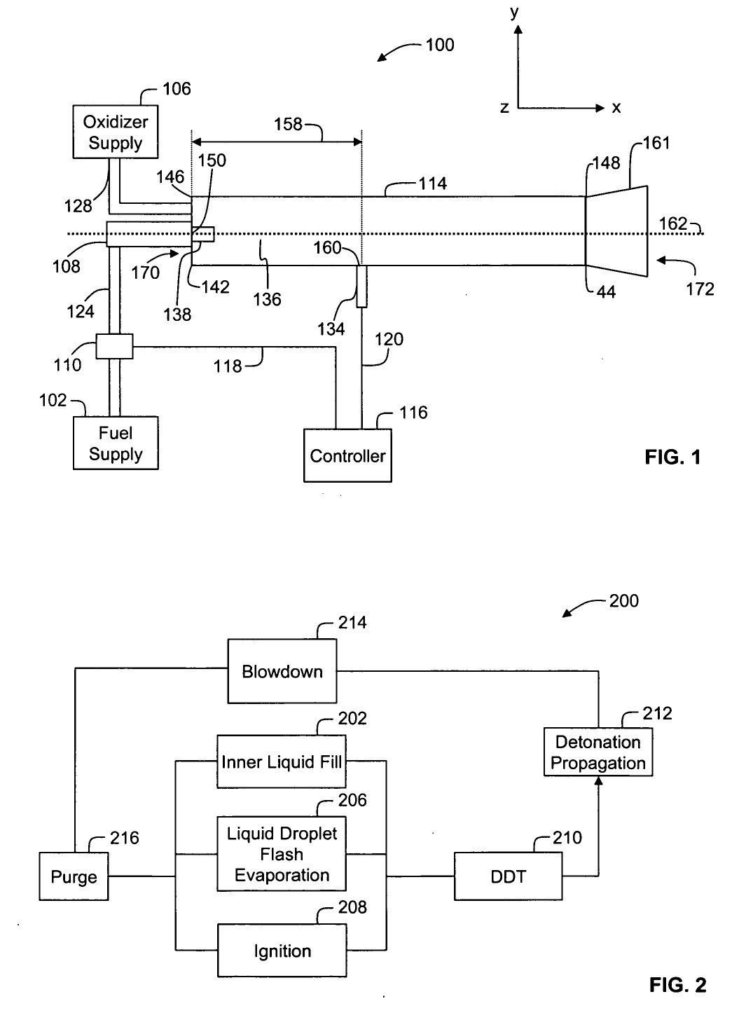

FIG. 1 is a block diagram of an exemplary embodiment of a system 100 for generating thrust. System 100 includes a fuel supply 102, an oxidizer supply 106, a fuel injector 108, a valve 110, an inner tube 114, a controller 116, a plurality of controller output lines 118 and 120, a fuel supply line 124, an oxidizer supply line 128, and an initiation device 134. Inner tube 114 has a hollow chamber 136.

Fuel injector 108 includes a nozzle 138. Fuel supply 102 includes a tank that stores fuel, such as a liquid fuel. For example, liquid fuel can be, but is not limited to being, butane, pentane, hexane, jet fuel (JP 10), or Jet-A fuel. As an example, the liquid fuel at high pressure, such as, near or above a critical pressure of the liquid fuel, is heated to have a temperature that is above a critical point of the liquid fuel. As another example, liquid fuel may be heated by a heater (not shown) to a high temperature, so that a significant portion of the liquid fuel flash vaporizes immediately, in a short duration of time, upon entering inner tube 114. In the example, the liquid fuel at high pressure is heated by a heater (not shown) located outside inner tube 114. An example of the short duration of time includes a time ranging from 0.01 millisecond (ms) to 1 ms. An example of the high temperature includes a range from and including 500 degrees Fahrenheit to 1000 degrees Fahrenheit. In one embodiment, oxidizer supply 106 is an oxidizer tank that stores an oxidizer. Examples of fuel injector 108 include, but are not limited to being, a flash vaporizing injector, a pressure-assist atomizer, an oxidizer-assist atomizer, and a supercritical liquid injector.

Valve 110 can be, but is not limited to being, a solenoid valve. As used herein, the term “controller” is not limited to just those integrated circuits referred to in the art as a controller, but broadly refers to a processor, a microprocessor, a microcontroller, a programmable logic controller, an application specific integrated circuit, and another programmable circuit. Initiation device 134 can be, but is not limited to being, a spark plug, a plasma ignitor, and/or a laser source. In the exemplary embodiment, each controller output line 118 and 120 is a conducting medium, such as a metal wire. Inner tube 114 is aligned substantially parallel to x-axis from a point 142 to a point 144, and from a point 146 to a point 148.

Controller 116 sends an “on” signal via controller output line 118 to valve 110. Upon receiving an “on” signal from controller 116, valve 110 actuates or opens. When valve 110 is open, fuel stored within fuel supply 102 is supplied via fuel supply line 124 to fuel injector 108. Fuel injector 108 atomizes fuel received via fuel supply line 124 into a plurality of droplets and supplies the droplets via nozzle 138 to a fuel injector port 150 or opening of inner tube 114. As an example, fuel injector 108 atomizes fuel received via fuel supply line 124 and injects the fuel directly into inner tube 114 via nozzle 138. Additionally, a flow of oxidizer is continuously supplied from oxidizer supply 106 via oxidizer supply line 128 to inner tube 114. In one embodiment, at least a portion of fuel received by inner tube 114 via port 150 flash vaporizes upon entering inner tube 114 and the inner tube 114 has a lower pressure than a pressure of the fuel. In an alternative embodiment, at least a portion of fuel received by inner tube 114 via port 150 remains in a liquid form upon entering inner tube 114.

Fuel received via fuel injector 108 and an oxidizer received via oxidizer supply line 128 flow through a pre-vaporization portion 158 of inner tube 114. Pre-vaporization portion 158 extends from point 142 to a point 160. The evaporation of the liquid fuel droplets is mostly completed in the pre-vaporization segment 158 due to the higher temperature of the oxidizer than that of the liquid droplets. After determining that a pre-determined amount of time has passed since valve 110 was opened, controller 116 transmits an “off” signal to valve 110 via controller output line 118. Valve 110 closes upon receiving an “off” signal.

Controller 116 sends a signal to initiation device 134 via controller output line 120. Upon receiving the signal via controller output line 120, initiation device 134 creates a spark within inner tube 114 at point 160. The spark within inner tube 114 ignites a mixture of fuel and oxidizer within inner tube 114 to generate an ignition kernel. The ignition kernel expands into a deflagration flame that accelerates into a turbulent flame and a detonation wave. The detonation wave propagates through a mixture of fuel and oxidizer within inner tube 114 to increase the pressure within inner tube 114. The combustion gases produced exit the inner tube 114 via a nozzle 161 coupled to inner tube 114 to generate thrust. Oxidizer from oxidizer supply 106 is channeled through inner tube 114 to facilitate scavenging or removing any combustion gases remaining within inner tube 114. The higher temperature of the oxidizer stream combined with flash vaporization process evaporates fuel within pre-vaporization portion 158. Fuel injector port 150 is located at an inlet or entry end 170 of inner tube 114. Inlet end 170 is located opposite to that of an outlet end 172 of inner tube 114 from which a plurality of combustion gases exit inner tube 114. Fuel injector port 150 is located along or substantially parallel to x-axis 162 of inner tube 114. The x-axis 162 is substantially parallel to a center-line along a longitudinal axis of inner tube 114.

FIG. 2 is a flow diagram of an exemplary method 200 for generating thrust. In one embodiment, the method 200 is executed by system 100 (shown in FIG. 1). Method 200 includes an inner fuel fill process 202, a liquid droplet flash evaporation process 206, an ignition process 208, a deflagration-to-detonation transition (DDT) process 210, a detonation propagation process 212, a blowdown process 214, and a purge process 216. A controller, such as controller 116, executes inner fuel fill process 202 for a sum of an inner fuel fill time and an inner lag time associated with the inner fuel fill time and the inner lag time is predetermined to synchronize the partial/complete fuel fill process with a time at which ignition is initiated within inner tube 114. During the inner fuel fill time, fuel is channeled into inner tube 114 via fuel injector port 150 and fills inner tube 114. The fuel enters inner tube 114 via fuel injector port 150 between an opening of valve 110 and a closing of valve 110 that consecutively follows the opening. Liquid droplet flash evaporation process 204 occurs at a very rapid rate in a time duration ranging from and including 0.01 ms to 1 ms. During the liquid droplet flash evaporation time, droplets that enter inner tube 114 via port 150 flash evaporate upon entering inner tube 114.

Controller 116 initiates the ignition process 208 at a predetermined time, typically towards the end of the inner fuel fill time. Upon receiving a signal from controller 116 via controller output line 120, a spark ignites a mixture of fuel and oxidizer within inner tube 114. Controller 116 synchronizes the inner fuel fill process 202, liquid droplet flash evaporation process 204, and the ignition process 208 in order to obtain detonations or quasidetonations in inner tube 114.

Controller 116 is preprogrammed with inputs of the beginning and the end of inner fuel fill process 202 at which respective fuel line valves open and close, and the fuel ignition initiation time. In an alternative embodiment, these inputs are stored in memory storage, such as a random access memory device or a read-only memory device, by a user. The memory is coupled to controller 116 and controller 116 retrieves the inner fuel fill time, the liquid droplet flash evaporation time, and the fuel ignition initiation time.

During DDT process 210, the ignition kernel grows into the deflagration, the deflagration transitions into the turbulent flame, and the turbulent flame further transitions into the detonation wave within inner tube 114. During detonation propagation process 212, the detonation wave propagates within inner tube 114 to increase pressure, temperature and velocity of gases within inner tube 114 and exits the inner tube 114 at the end 172 of the exit nozzle 161. During the blowdown process 214, the combustion gases exit from nozzle 161 to create a thrust. During purge process 216, oxidizer flows within inner tube 114 to scavenge any of the combustion gases left within inner tube 114.

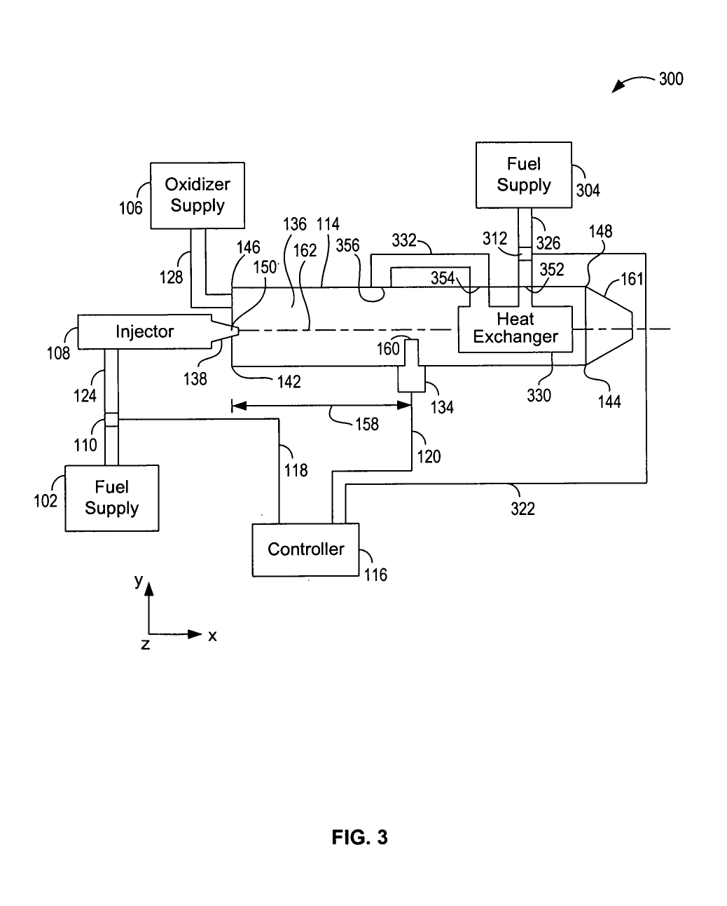

FIG. 3 is a block diagram of an exemplary embodiment of a system 300 for generating thrust. System 300 includes fuel supply 102, a fuel supply 304, oxidizer supply 106, fuel injector 108, valve 110 and a valve 312, inner tube 114, controller 116, controller output lines 118 and 120, a controller output line 322, fuel supply line 124, a fuel supply line 326, oxidizer supply line 128, a heat exchanger 330, a transition tube 332, and initiation device 134. Fuel supply 304 includes a tank that stores fuel, such as the liquid fuel.

Valve 312 can be, but is not limited to being, a solenoid valve. Heat exchanger 330 and/or transition tube 332 can be, but is not limited to being, fabricated from a metal material, such as, but not limited to, stainless steel or aluminum. In an alternative embodiment, heat exchanger 330 is positioned externally to inner tube 114 and is in contact with inner tube 114. In the exemplary embodiment, controller output line 322 is a conducting medium, such as a metal wire.

Controller 116 sends an “on” signal via controller output line 322 to valve 312. Upon receiving an “on” signal via controller output line 322, valve 312 actuates or opens. When valve 312 is open, fuel from fuel supply 304 is supplied via fuel supply line 326 to a fuel supply port 352 or opening of inner tube 114. In an alternative embodiment, fuel supply line 326 is connected via a fuel injector (not shown) to fuel supply port 352. In the alternative embodiment, when valve 312 is opened, fuel flows via fuel supply line 326 to the fuel injector 108 (this connection of pipes not shown), wherein the fuel is atomized into a plurality of droplets, which are channeled into inner tube 114 via fuel supply port 352.

Heat exchanger 330 receives fuel from fuel supply port 352 and converts the fuel from a liquid form into a vapor form. As an example, heat exchanger 330 receives fuel via fuel supply port 352 and converts the fuel from a liquid form into a gaseous form by transferring heat generated within inner tube 114 to the fuel received by heat exchanger 330.

Transition tube 332 receives fuel via a transition tube input port 354 formed within inner tube 114 and supplies the fuel to a transition tube output port 356 formed within inner tube 114. Fuel from transition tube 332 enters inner tube 114 via transition tube output port 356. Fuel enters into inner tube 114 via ports 356 and 150, and oxidizer from oxidizer supply 106 enters inner tube 114.

Fuel received via fuel injector 108 and oxidizer received via oxidizer supply line 128 flow through pre-vaporization portion 158 of inner tube 114. After determining that a pre-determined amount of time has passed since valve 312 was opened, controller 116 an “off” signal to valve 312 to controller output line 322. Valve 312 closes upon receiving an “off” signal.

When controller 116 sends a signal to initiation device 134 via controller output line 120, a mixture of fuel and oxidizer is ignited within inner tube 114, a turbulent flame accelerates and transitions to a detonation or a quasidetonation; and thrust is generated by the combustion gases that exit inner tube 114. The heat generated within inner tube 114 also facilitates heat exchanger 330 to cause fuel within heat exchanger 330 to be evaporated.

Fuel injector port 150 is located at a different location along x-axis 162 of inner tube 114 than a location of transition tube output port 356 along x-axis 162. For example, in the exemplary embodiment, transition tube output port 356 is closer to initiation device 134 than fuel injector port 150.

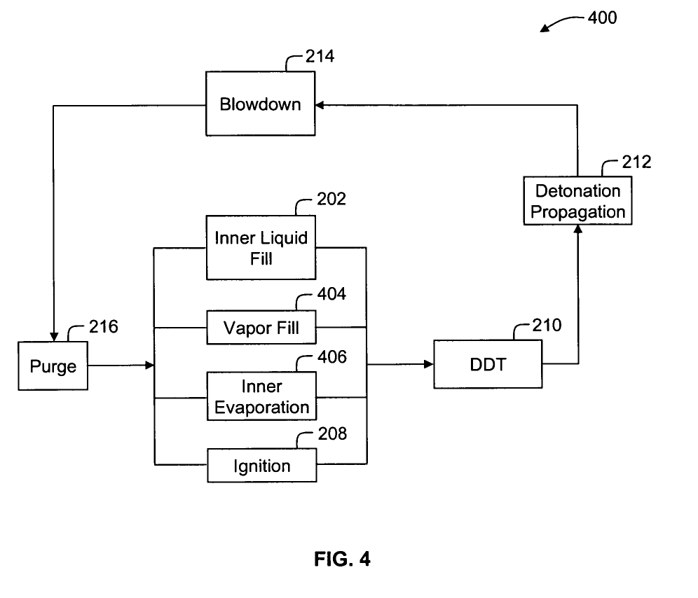

FIG. 4 is a flow diagram of an exemplary method 400 for generating thrust. In one embodiment, the method 400 is executed by system 300 (shown in FIG. 1). Method 400 includes inner fuel fill process 202, a vapor fill process 404, an inner evaporation process 406, ignition process 208, DDT process 210, detonation propagation process 212, blowdown process 214, and purge process 216. Controller 116 executes vapor fill process 404 for duration of a vapor fill time. During the vapor fill time, gaseous fuel is channeled into inner tube 114 via transition output port 356 and fills inner tube 114. The gaseous fuel enters inner tube 114 via transition output port 356 between an opening of valve 312 and a closing of valve 312 that consecutively follows the opening.

During the inner evaporation process 406, fuel that is channeled into inner tube 114 via fuel injector port 150 evaporates from a liquid into a gaseous form within pre-vaporization portion 158. Controller 116 synchronizes the inner fuel fill time with the vapor fill time, and the ignition time.

Controller 116 is preprogrammed with inputs of the beginning and the end of inner fuel fill process 202 at which respective fuel line valves open and close, and the fuel ignition initiation time. In an alternative embodiment, these inputs are stored in the memory storage. Controller 116 retrieves the inner fuel fill time, the liquid droplet flash evaporation time, and the fuel ignition initiation time.

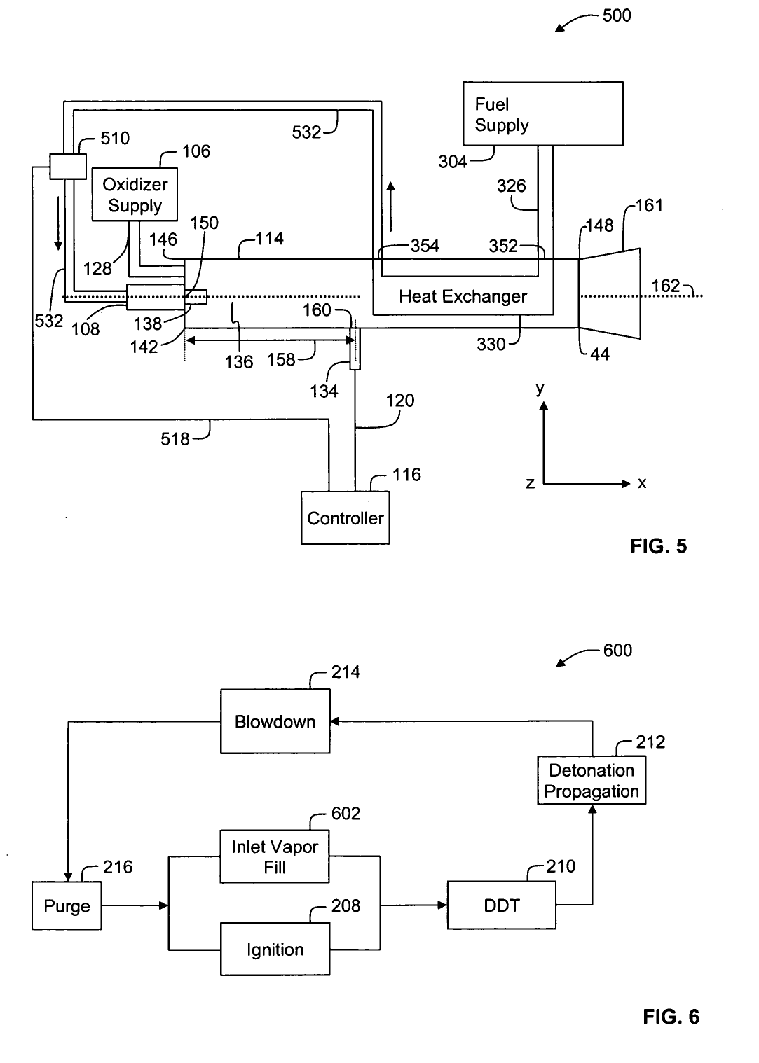

FIG. 5 is a block diagram of an exemplary embodiment of a system 500 for generating thrust. System 500 includes fuel supply 304, oxidizer supply 106, fuel injector 108, a valve 510, inner tube 114, controller 116, controller output line 120, a controller output line 518, fuel supply line 326, oxidizer supply line 128, heat exchanger 330, a transition tube 532, and initiation device 134.

Valve 510 can be, but is not limited to being, a solenoid valve. Transition tube 532 can be, but is not limited to being, fabricated from a metal material, such as, but not limited to, stainless steel or aluminum. In the exemplary embodiment, controller output line 518 is a conducting medium, such as a metal wire.

Transition tube 532 receives fuel via transition tube input port 354 formed within inner tube 114. Controller 116 sends an “on” signal via controller output line 518 to valve 510. Upon receiving an “on” signal via controller output line 518, valve 510 actuates or opens. When valve 510 is open, fuel from fuel supply line 532 is supplied to fuel injector 108. Fuel injector 108 converts fuel received via fuel supply line 532 into a plurality of droplets and/or fuel vapor and supplies the droplets and/or fuel vapor to inner tube 114 via fuel injector port 150. Fuel received via fuel injector 108 and oxidizer received via oxidizer supply line 128 flow through pre-vaporization portion 158 of inner tube 114. After determining that a pre-determined amount of time has passed since valve 312 was opened, controller 116 sends an “off” signal to valve 510 via controller output line 518. Valve 510 closes upon receiving an “off” signal.

When controller 116 sends a signal to initiation device 134 via controller output line 120, a mixture of fuel and oxidizer is ignited within inner tube 114, a turbulent flame accelerates and transitions to a detonation or a quasidetonation; and thrust is generated by the combustion gases that exit inner tube 114. The heat generated within inner tube 114 also facilitates heat exchanger 330 to cause fuel within heat exchanger 330 to be evaporated.

FIG. 6 is a flow diagram of an exemplary method 600 for generating thrust. In one embodiment, the method 600 is executed by system 500 (shown in FIG. 5). Method 600 includes an inlet vapor fill process 602, ignition process 208, DDT process 210, detonation propagation process 212, blowdown process 214, and purge process 216. During the inlet vapor fill time, gaseous fuel is channeled into inner tube 114 via fuel injector port 150 and fills inner tube 114. The gaseous fuel enters inner tube 114 via fuel injector port 150 between an opening of valve 510 and a closing of valve 510 that consecutively follows the opening.

Controller 116 is preprogrammed with inputs of the beginning and the end of inlet vapor fill process 602 at which valve 510 opens and closes, and the fuel ignition initiation time. In an alternative embodiment, these inputs are stored in memory storage, such as a random access memory device or a read-only memory device, by a user. The memory is coupled to controller 116, which retrieves the inlet vapor fill time, the liquid droplet flash evaporation time, and the fuel ignition initiation time.

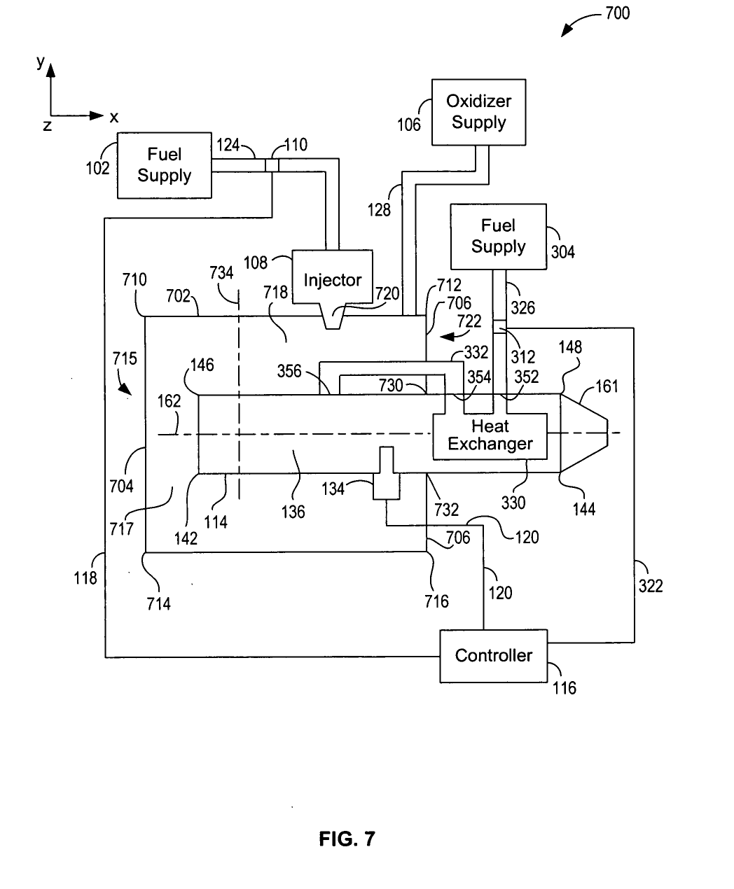

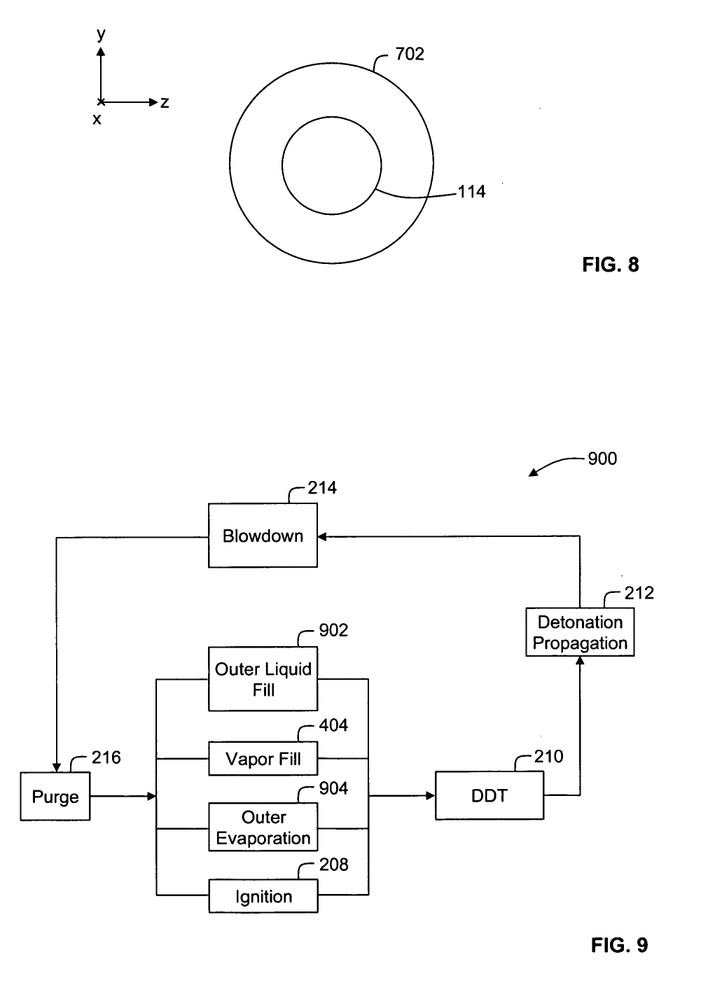

FIGS. 7 and 8 are schematic diagrams of an alternative embodiment of a system 700 for generating thrust. System 700 includes fuel supplies 102 and 304, oxidizer supply 106, fuel injector 108, valves 110 and 312, inner tube 114, controller 116, controller output lines 118, 120, and 322, fuel supply lines 124 and 326, oxidizer supply line 128, heat exchanger 330, transition tube 332, initiation device 134, an outer tube 702, and a plurality of end caps 704 and 706.

Outer tube 702 extends parallel to the x-axis from a point 710 to a point 712 and from a point 714 to a point 716. Accordingly, outer tube 702 is aligned substantially concentrically with respect to inner tube 114, and each of outer tube 702 and inner tube 114 is a hollow cylinder having a substantially circular cross-section. However, alternatively, outer tube 702 and inner tube 114 may not be concentrically aligned. In yet another alternative embodiment, outer tube 702 and inner tube 114 have non-circular cross-sectional profiles, such as, a polygonal cross-section, a triangular cross-section, a square cross-section, and/or a hexagonal cross-section. In another alternative embodiment, inner tube 114 has a different cross-sectional profile than that of outer tube 702. Cross-sectional profiles of inner tube 114 and outer tube 702 are formed in a standard y-z plane formed by a y-axis and a z-axis.

Although each of outer tube 702 and inner tube 114 extend substantially linearly along the x-axis, in an alternative embodiment, outer tube 702 and inner tube 114 extend in annular configuration, or helical spirals, along the x-axis and as such are not parallel to the x-axis. Inner tube 114 has a diameter ranging from 1.5 inches to 2.5 inches, and outer tube 702 has a diameter ranging from two inches to three inches. End cap or head-end 704 extends from point 710 to point 714. Head-end 704 is coupled, such as with a friction fit, to an end of 715 outer tube 702. Alternatively, head-end 704 is coupled to end 715 using any other suitable means. Outer tube 702 defines a hollow chamber 717 that extends substantially parallel to the x-axis and inner tube 114 defines hollow chamber 136 that extends substantially parallel to the x-axis. A plenum 718, space, and/or gap, is defined within hollow chamber 717, between outer tube 702 and inner tube 114. An end cap 706 is coupled to outer tube 702 and to inner tube 114 using any suitable means. End cap 706 is aligned substantially concentrically with outer tube 702 and circumscribes inner tube 114. End cap 706 substantially seals plenum 718 from an end 722 that is opposite to end 715 and opposite head-end 704. Plenum 718 extends from head-end 704 to end cap 706. End cap 706 extends from point 712 to a point 730 and from point 716 to a point 732.

Fuel injector 108 atomizes fuel received via fuel supply line 124 into a plurality of droplets and supplies the droplets via nozzle 138 to an outer tube port 720 or opening of outer tube 702. Additionally, oxidizer is supplied from oxidizer supply 106 via oxidizer supply line 128 to outer tube 702. The function of controller 116 is similar to the one described in the exemplary embodiments shown in FIGS. 1, 3 and 5.

Fuel received via fuel injector 108 and oxidizer received via oxidizer supply line 128 flow through plenum 718. Heat within hollow chamber 136 is transferred via inner tube 114 to plenum 718 and the heat converts fuel received via fuel injector port 150 from a liquid form into a gaseous form. Fuel and oxidizer flow within plenum 718 towards head-end 704 and is directed from head-end 704 towards hollow chamber 136. Fuel flows into hollow chamber 136.

A spark within inner tube 114 ignites a mixture of fuel and oxidizer, on instructions from controller 116, within inner tube 114 to generate the ignition kernel, which transitions to a detonation or a quasidetonation, forming the high pressure, high temperature and high velocity combustion gases. The combustion gases exit inner tube 114 via nozzle 161 attached to inner tube 114 to generate a thrust. Heat generated by the detonation wave within inner tube 114 transfers via hollow chamber 136 and inner tube 114 to plenum 718 and fully or partially evaporates fuel within plenum 718.

Outer tube port 720 is located at a different location than a location of transition tube output port 356. For example, outer tube port 720 is located at a larger radius along a radial axis 734 than a radius at which transition tube output port 356 is located. Radial axis 734 is substantially perpendicular to x-axis 162. As another example, transition tube output port 356 is located closer along x-axis 162 to initiation device 134 than a location at which outer tube port 720 is located along x-axis 162. As yet another example, transition tube output port 354 is located at a different location along x-axis 162 than a location at which outer tube port 720 is located along x-axis 162.

FIG. 9 is a flow diagram of an alternative embodiment of a method 900 for generating thrust and the method 900 is executed by system 700. The method 900 includes an outer fill process 902, vapor fill process 404, an outer evaporation process 904, ignition process 208, DDT process 210, detonation propagation process 212, blowdown process 214, and purge process 216. Controller 116 executes outer fill process 902 for duration of an outer fill time. During the outer fill time, the liquid fuel is channeled into outer tube 702 via outer tube port 720 and fills outer tube 702. Fuel in a liquid form is channeled into outer tube 702 via outer tube port 720 between an opening of valve 110 and a closing of valve 110 that consecutively follows the opening.

During outer evaporation process 904, fuel that is channeled into outer tube 702 via outer tube port 720 evaporates from a liquid into a gaseous form within plenum 718. Controller 116 synchronizes the outer fill time with the vapor fill time and the fuel ignition initiation time.

Controller 116 is preprogrammed with inputs of the beginning and the end of inner fuel fill process at which respective fuel line valves open and close, and the fuel ignition initiation time. In an alternative embodiment, these inputs are stored in memory storage, such as a random access memory device or a read-only memory device, by a user. The memory is coupled to controller 116, which retrieves the outer fill time, the vapor fill time, the liquid droplet flash evaporation time, and the fuel ignition initiation time.

Before the methods for generating thrust are executed within systems 100, 300, 500, and 700 for a first time, a preheated stream of air from a compressor is supplied to inner tube 114 to heat hollow chamber 136 of inner tube 114. Heat is transmitted from the preheated air, which in turn is transferred from hollow chamber 136 to fuel within heat exchanger 330 to convert the liquid fuel into the fuel vapor. Heat transferred from the preheated air supply also converts fuel received via fuel injector port 150 and outer tube port 720 from a liquid form into a gaseous form. Moreover, heat transferred from the preheated air supply also converts fuel within plenum 718 from a liquid form into a gaseous form. It is also noted that a range of temperatures before generation of the detonation wave within inner tube 114 extend from and including 250 degrees Kelvin to 700 degrees Kelvin, and a range of pressures within inner tube 114 extend from 0.5 atmospheres to 20 atmospheres.

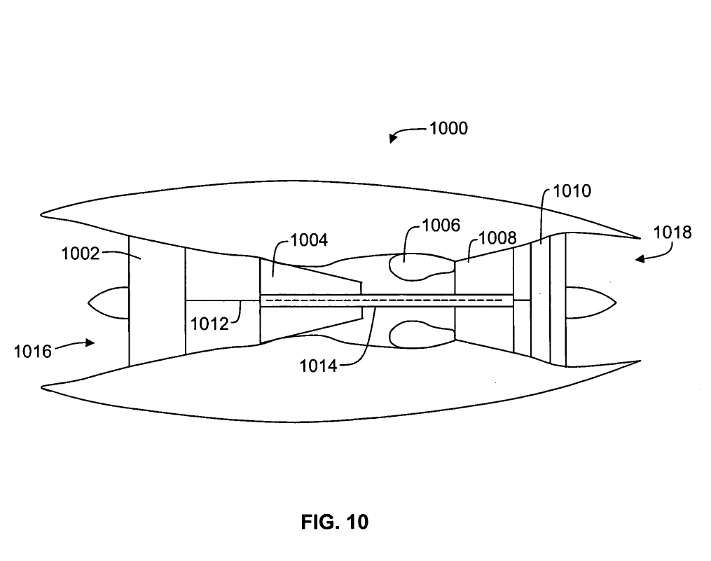

FIG. 10 is a schematic of an exemplary gas turbine engine 1000 including a low pressure compressor 1002, a high pressure compressor 1004, and a pressure-rise combustion system 1006. Engine 1000 also includes a high-pressure turbine 1008 and a low-pressure turbine 1010. Low-pressure compressor 1002 and low-pressure turbine 1010 are coupled by a first shaft 1012, and high-pressure compressor 1004 and high-pressure turbine 1008 are coupled by a second shaft 1014. In one embodiment, engine 1000 is a F110/129 engine available from General Electric Aircraft Engines, Cincinnati, Ohio. Pressure-rise combustion system 1006 includes at least one system 100 except that the at least one system 100 is controlled by controller 116. Alternatively, pressure-rise combustion system 1006 includes at least one system 300 except that the at least one system 300 is controlled by controller 116. In another alternative embodiment, pressure-rise combustion system 1006 includes at least one system 500 except that the at least one system 500 is controlled by controller 116. In yet another alternative embodiment, pressure-rise combustion system 1006 includes at least one system 700 except that the at least one system 700 is controlled by controller 116.

In operation, oxidizer flows through low-pressure compressor 1002 from an inlet side 1016 of engine 1000 and is supplied from low-pressure compressor 1002 to high-pressure compressor 1004 to generate compressed oxidizer. Compressed oxidizer is delivered to oxidizer supply line 128. Compressed oxidizer is mixed with fuel and ignited to generate the combustion gases. The combustion gases generated with pressure-rise combustion system 1006 are channeled from pressure-rise combustion system 1006 to drive turbines 1008 and 1010 and provide thrust from an outlet 1018 of engine 1000. In an alternative embodiment, any of systems 100, 300, 500, and 700 can be, but are not limited to being, used for other supersonic propulsion applications, such as, rocket boosters, rocket engines, missiles, and an unmanned combat aerial vehicle (UCAV).

Technical effects of the herein described systems and methods for generating thrust include injection fuel at different locations along at least one of x-axis 162 and radial axis 734. Due to the different locations, thrust is generated in an effective and quick manner. Other technical effects include synchronizing as described above. Still further technical effects include a transfer of heat from hollow chamber 136 to plenum 718 to vaporize fuel within plenum 718. Other technical effects include provision of pre-vaporization portion 158 to vaporize fuel within pre-vaporization portion 158. Still further technical effects include flash vaporization of at least a portion of fuel in the liquid phase upon entering inner tube 114.

While the invention has been described in terms of various specific embodiments, those skilled in the art will recognize that the invention can be practiced with modification within the spirit and scope of the claims.

What is claimed is:

1. A system for generating thrust, said system comprising:
a first injector;
an inner tube configured to receive fuel from said first injector via a first port of said inner tube, wherein at least a portion of fuel in liquid phase received by said inner tube is configured to flash vaporize upon entering said inner tube via the first port.

2. A system in accordance with claim 1, wherein said first injector is one of a pressure-assist atomizer and an oxidizer-assist atomizer.

3. A system in accordance with claim 1 wherein said inner tube comprises a pre-vaporization portion configured to vaporize fuel from a liquid form into a gaseous form.

4. A system in accordance with claim 1, wherein said inner tube configured to receive fuel from a second port spaced apart along a center axis of said inner tube, wherein said first port injects fuel at a different location along said center axis than said second port.

5. A system in accordance with claim 4 further comprising one of a fuel supply line and a second injector configured to inject fuel into said inner tube at said second port.

6. A system in accordance with claim 4 further comprising an outer tube circumscribing said inner tube, said outer tube configured to receive fuel from a third port located along said center axis at a location different than a location of said first port.

7. A system in accordance with claim 4 further comprising an outer tube circumscribing said inner tube, said outer tube configured to receive fuel from a third port located along said center axis at a location different than the locations of said first and second ports.

8. A system in accordance with claim 4 further comprising a heat exchanger configured to vaporize fuel received via said second port from a liquid form into a gaseous form.

9. A system in accordance with claim 4 further comprising:
a heat exchanger configured to vaporize fuel received via said second port from a liquid form into a gaseous form; and
a transition tube configured to supply gaseous fuel to said inner tube.

10. A system in accordance with claim 4 further comprising:
an initiation device configured to ignite fuel within said inner tube; and
a controller configured to synchronize a first time with a second time, a third time, and a fourth time, wherein the first time comprises an inner fuel fill time during which fuel in a liquid form is channeled via said first port into said inner tube, the second time comprises a vapor fill time during which fuel in a vapor form is channeled into said inner tube, the third time comprises an ignition time during which fuel is ignited within said inner tube, and the fourth time comprises an inner evaporation time during which fuel that enters via said first port into said inner tube is converted from a liquid form into a gaseous form.

11. A system in accordance with claim 4 further comprising:
an outer tube circumscribing said inner tube and configured to receive fuel from a third port;
an initiation device configured to ignite fuel within said inner tube; and
a controller configured to synchronize a first time with a second time, a third time, and a fourth time, wherein the first time comprises an outer liquid fill time during which fuel in a liquid form is filled via the third port into said outer tube, the second time comprises a vapor fill time during which fuel in a vapor form is filled via said second port into said inner tube, the third time comprises an ignition time during which fuel is ignited within said inner tube, and the fourth time comprises an outer evaporation time during which fuel that enters via the third port into said outer tube is converted from a liquid form into a gaseous form.

12. A system in accordance with claim 4 further comprising an outer tube configured to receive fuel from a third port, wherein a portion of said inner tube is located within a hollow chamber of said outer tube, said inner and outer tubes configured to form a plenum between said inner and outer tubes, and said inner tube configured to evaporate fuel within the plenum.

13. A system for generating energy, said system comprising:
a compressor configured to compressed oxidizer;
a first injector; and
an inner tube configured to receive fuel from said first injector via a first port of said inner tube, wherein at least a portion of fuel received by said inner tube configured to flash vaporize upon entering said inner tube via the first port.

14. A system in accordance with claim 13, wherein said first injector is one of a pressure-assist atomizer and an oxidizer-assist atomizer.

15. A system in accordance with claim 13, wherein said inner tube comprises a pre-vaporization portion configured to vaporize fuel from a liquid form into a gaseous form.

16. A system in accordance with claim 13, wherein said inner tube configured to receive fuel from a second port spaced apart along a center axis of said inner tube, wherein said first port injects fuel at a different location along said center axis than said second port.

17. A system in accordance with claim 16 further comprising one of a fuel supply line and a second injector configured to inject fuel into said inner tube at said second port.

18. A method for generating thrust, said method comprising:
receiving fuel from a first injector via a first port of an inner tube; and
flash vaporizing at least a portion of the fuel received via the first port upon entering the inner tube.

19. A method in accordance with claim 18 further comprising receiving fuel from a second port spaced apart along a center axis of the inner tube, wherein the first port is located at a different location along the center axis than the second port.

20. A method in accordance with claim 19 further comprising:
circumscribing said inner tube by an outer tube having a third port; and
receiving fuel from the third port located along the center axis at a location different than a location of the first port.
